(19) United States
(12) Patent Application Publication
(10) Pub. No.: US 2009/0050618 A1
(43) Pub. Date: Feb. 26, 2009

(54) CIRCUIT DEVICE FOR STEAM ENGINE

(75) Inventor: Fei JIANG, Baoan Shenzhen City (CN)

Correspondence Address: BROWDY AND NEIMARK, P.L.L.C.;624 NINTH STREET, NW, SUITE 300, WASHINGTON, DC, 20001-5303, US

(73) Assignee: Mitco International LTD, Taipei (TW)

(21) Appl. No.: 11/955,999

(22) Filed: Dec. 13, 2007

(30) Foreign Application Priority Data
Aug. 23, 2007 (CN) 200720129289.2

(51) Int. Cl. H05B 1/00

(52) U.S. Cl. 219/241; 219/441

(57) ABSTRACT

A circuit device for a steam engine having a power unit is electrically connected to a positive electrode and a negative electrode of the power unit includes a switching unit having a positive voltage contact set and a negative voltage contact set and is switchable between a first mode, in which the power unit provides electricity to first contacts of the positive and negative voltage contact sets, and a second mode, in which the power unit provides electricity to second contacts of the positive and negative voltage contact sets, a heater module having an input end connected to first and second contacts of the positive voltage contact set and an output end thereof connected to the first contact of the negative voltage contact set, and a voltage step-down unit connected in series to the output end of the heater module and the second contact of the negative voltage contact set.

### BACKGROUND OF THE INVENTION

1. Field of the Invention

The present invention relates to a steam engine and more specifically, to a circuit device for a steam engine.

2. Description of the Related Art

Regular steam engines are commonly used in steam cleaners or air humidifiers. A steam engine is generally operated in such a way that an electrical heater heats the water in a water tank and then steam is generated for output through a piping. Therefore, the output steam in a steam cleaner is used for the cleaning purpose, and, the output steam in a humidifier is used for the purpose of moistening the air.

However, the circuit design of the conventional product based on the steam engine simply provides one single power output for one single purpose. The steam cleaner needs to output enhanced steam for cleaning clothes and removing wrinkles of clothes, and the air humidifier needs long time and less enhanced steam for moistening the indoor air, so both are different in requirement for steam output power. In light of this, different steam engines may be required for different application purposes. When many products based on different steam engines are owned, where is to store these products is also a problem for the user. Therefore, the conventional products based on the steam engines are limited to single purpose of usage to be defective, in need of improvement.

### SUMMARY OF THE INVENTION

The present invention has been accomplished under the circumstances in view. It is therefore the main object of the present invention to provide a circuit device for use in a steam engine for enabling the steam engine to selectively function as cleaning and air humidification.

To achieve the object of the present invention, the circuit device is electrically connected to a power unit of a steam engine, wherein the power unit has a positive electrode and a negative electrode. The circuit device includes a switching unit, a heater module, and a voltage step-down unit. The switching unit includes a positive voltage contact set and a negative voltage contact set. Each of the positive and negative voltage contact sets includes a common contact, a first contact, and a second contact. The common contact of the positive voltage contact set is electrically connected to the positive electrode of the power unit of the steam engine. The common contact of the negative voltage contact set is electrically connected to the negative electrode of the power unit of the steam engine. The switching unit is switchable between a first mode and a second mode. Each of the common contacts of the positive and negative voltage contact sets is electrically connected to the associated first contact of the positive or negative voltage contact set when the switching unit is in the first mode. Each of the common contacts of the positive and negative voltage contact set is electrically connected to the second contact of the positive or negative voltage contact set when the switching unit is in the second mode. The heater module includes an input terminal electrically connected to the first and second contacts of the positive voltage contact set, and a negative terminal electrically connected to the first contact of the negative voltage contact set. The voltage step-down unit is electrically connected in series to the output terminal of the heater module and the second contact of the negative voltage contact set.

When the switching unit is in the first mode, electric current goes through the heater module except the voltage step-down unit to enable the steam engine to provide a high power output for cleaning purpose. When the switching unit is in the second mode, electric current goes through the heater module and the voltage step-down unit to enable the steam engine to provide a low power output for air humidifying purpose.

### BRIEF DESCRIPTION OF THE DRAWINGS

FIG. 1 is a circuit diagram of the circuit device for the steam engine in accordance with the present invention, illustrating that the switching unit is in the first mode.

FIG. 2 is similar to FIG. 1, illustrating that the switching unit is in the second mode.

### DETAILED DESCRIPTION OF THE INVENTION

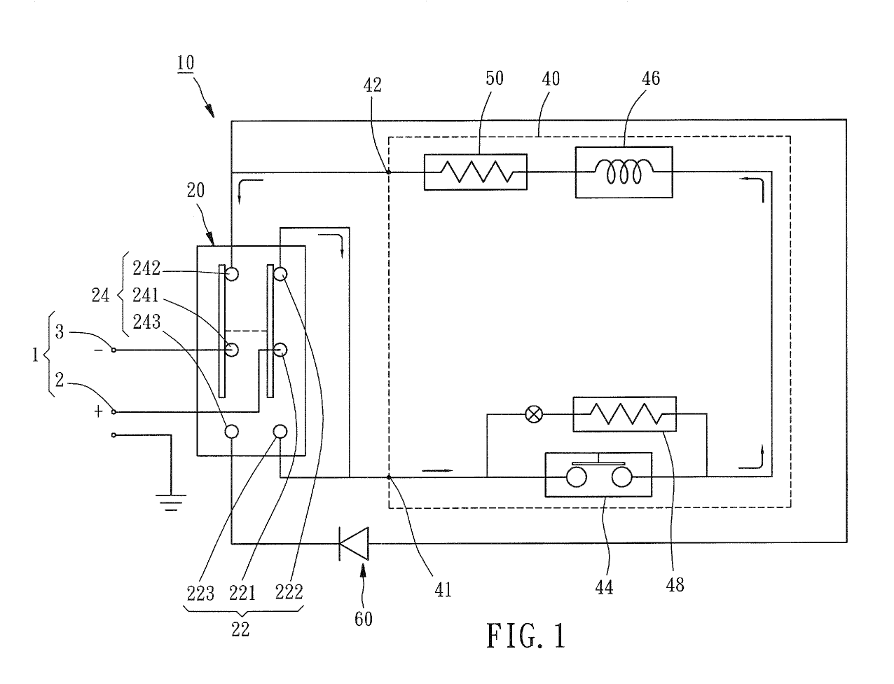

Referring to FIG. 1, a circuit device 10 for use in a steam engine in accordance with the present invention is shown electrically connected to a power unit 1 of the steam engine. The power unit 1 includes a positive electrode 2 and a negative electrode 3. The circuit device 10 includes a switching unit 20, a heater module 40, and a voltage step-down unit 60.

The switching unit 20 is a double-pole double-throw switch selected from a group consisting of toggle switch, slide switch, seesaw switch, or push-button switch. The switching unit 20 includes a positive voltage contact set 22 and a negative voltage contact set 24. The positive voltage contact set 22 includes a common contact 221, a 20 first contact 222, and a second contact 223. The negative voltage contact set 24 includes a common contact 241, a first contact 242, and a second contact 243. The common contact 221 of the positive voltage contact set 22 is electrically connected to the positive electrode 2. The common contact 241 of the negative voltage contact set 24 is electrically connected to the negative electrode 3. The switching unit 20 is 25 switchable between a first mode and a second mode. When the switching unit 20 is in the first mode, the common contact 221 of the positive voltage contact set 22 is electrically connected to the first contact 222 of the positive voltage contact set 22, and the common contact 241 of the negative voltage contact set 24 is electrically connected to the first contact 242 of the negative voltage contact set 24. When the switching unit 20 is in the second mode, the common contact 221 of the positive voltage contact set 22 is electrically connected to the second contact 223 of the positive voltage contact set 22, and the common contact 241 of the negative voltage contact set 24 is electrically connected to the second contact 243 of the negative voltage contact set 24.

The heater module 40 includes an input terminal 41, an output terminal 42, a temperature controller 44, an electrothermal element 46, a display 48, and an over-temperature fuse 50. The temperature controller 44 is electrically connected to the first contact 222 and second contact 223 of the positive voltage contact set 22. The electrothermal element 46 is electrically connected in series to an output end of the temperature controller 44, for controllably heating the water in a water tank of the steam engine into steam. The temperature controller 44 can control the electric current flowing through the electrothermal element 46 for thermostatic control. The display 48 is electrically connected in parallel to the temperature controller 44, for indicating the operational status of the heater module 40. The over-temperature fuse 50 is electrically connected in series to the electrothermal element 46 and the first contact 242 of the negative voltage contact set 24, for preventing the electrothermal element 46 from over-temperature damage. According to the present embodiment, the temperature controller 44 is electrically connected to the positive voltage contact set 22, i.e., the input terminal 41 of the heater module 40, and the over-temperature fuse 50 is electrically connected to the first contact 242 of the negative voltage contact set 24, i.e., the output terminal 42 of the heater module 40.

The voltage step-down unit 60 is a diode electrically connected in series to the output terminal 42 of the heater module 40 and the second contact 243 of the negative voltage contact set 24. The voltage step-down unit 60 allows electric current to pass therethrough and how the electric current flows forward is from the output terminal 42 of the heat module 40 toward the second contact 243 of the negative voltage contact set 24.

When the user needs enhanced steam to clean clothes and to eliminate wrinkles from the clothes, the user can switch the switching unit 20 to the first mode. At the meantime, the power unit 1 supplies electricity via the first contact 222 of the positive voltage contact set 22 and the first contact 242 of the negative voltage contact set 24 to the heater module 40 directly and the electric current flows through the heater module 40 except the voltage step-down unit 60, enabling the steam engine to provide 1500 W high power output for cleaning clothes with enhanced steam.

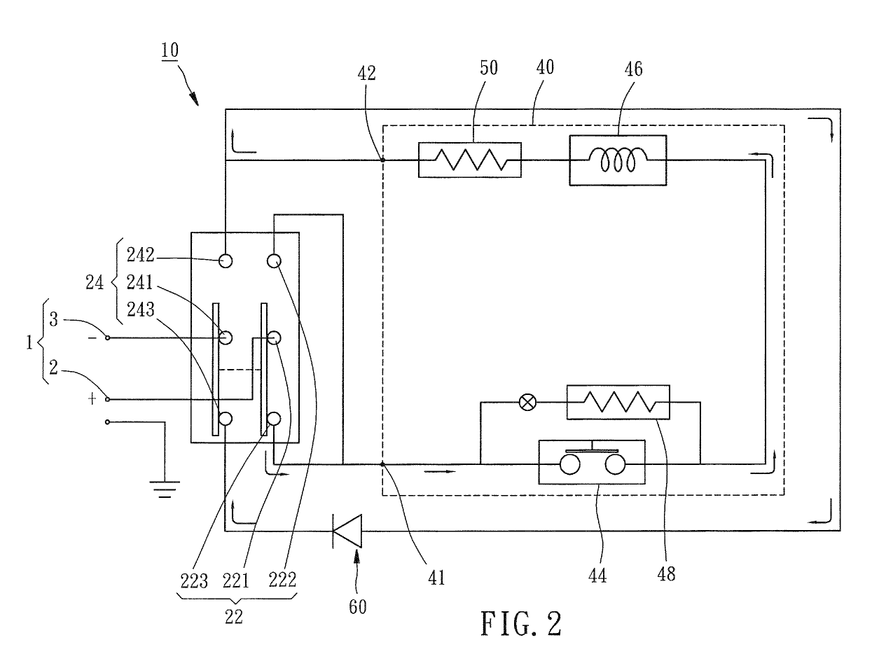

Referring to FIG. 2, when the user intends to operate the steam engine to moisten to the indoor air, the user can switch the switching unit 20 to the second mode. At the meantime, the power unit 1 supplies electricity through the second contact 223 of the positive voltage contact set 22 and the second contact 243 of the negative voltage contact set 24 for the heater module 40 and the voltage step-down unit 60. The voltage step-down unit 60 drops the output power of the heater module 40 to the level of 500 W to reduce the steam output of the steam engine. Further, when the steam engine is operated under the first mode (high power output for outputting enhanced steam for cleaning purpose) and the second mode model (low power output for adding moisture to the air) under the condition that the water tank is full for comparison, the operating time of the steam engine under the second mode is much longer than the operating time of the steam engine under the first mode. Therefore, the circuit device 10 of the present invention enables the steam engine to satisfy the requirement for lower power output and long operation time.

As stated above, the circuit device 10 of the present invention enables one single steam engine to provide a steam cleaning function and a humidifying function, eliminating the drawback of the aforementioned conventional steam engine design. Simply by means of switching the switching unit 20, the steam engine provides two different power outputs to fit different application purposes. In other words, the invention eliminates the drawback of one single purpose of the prior art design and brings convenience for the user.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A circuit device electrically connected to a power unit of a steam engine, said power unit having a positive electrode and a negative electrode, said circuit device comprising:
a switching unit having a positive voltage contact set and a negative voltage contact set, each of said positive and negative voltage contact sets having a common contact, a first contact, and a second contact, said common contact of said positive voltage contact set being electrically connected to said positive electrode of said power unit of said steam engine, the common contact of said negative voltage contact set being electrically connected to said negative electrode of said power unit of said steam engine, said switching unit being switchable between a first mode and a second mode, said common contact of said positive voltage contact set being electrically connected to the first contact of said positive voltage contact set and said common contact of said negative voltage contact set being electrically connected to the first contact of said negative voltage contact set when said switching unit is in said first mode, said common contact of said positive voltage contact set being electrically connected to the second contact of said positive voltage contact set and said common contact of said negative voltage contact set being electrically connected to the second contact of said negative voltage contact set when said switching unit is in said second mode.
a heater module having an input terminal and a negative terminal, said input terminal being electrically connected to the first contact and second contact of said positive voltage contact set, said negative terminal being electrically connected to the first contact of said negative voltage contact set; and
a voltage step-down unit electrically connected in series to the output terminal of said heater module and the second contact of said negative voltage contact set;
wherein when said switching unit is in said first mode, electric current goes through said heater module except said voltage step-down unit to enable said steam engine to provide a high power output for cleaning purpose; when said switching unit is in said second mode, electric current goes said heater module and said voltage step-down unit to enable said steam engine to provide a low power output for air humidifying purpose.

2. The circuit device as claimed in claim 1, wherein said heater module comprises a temperature controller and an electrothermal element, said temperature controller having an input end and an output end, said input end being electrically connected to the first and second contacts of said positive voltage contact set, said electrothermal element being electrically connected in series to said output end of said temperature controller for being controlled by said electrothermal element.

3. The circuit device as claimed in claim 2, wherein said heater module further comprises a display electrically connected in parallel to said temperature controller for indicating operation status of said heater module.

4. The circuit device as claimed in claim 2, wherein said heater module further comprises an over-temperature fuse electrically connected in series to said electrothermal element and the first contact of said negative voltage contact set for preventing said electrothermal element from over-temperature damage.

5. The circuit device as claimed in claim 1, wherein said switching unit is a double-pole double-throw switch.

6. The circuit device as claimed in claim 5, wherein said switching unit is selected from a group consisting of slide switch, toggle switch, seesaw switch, and push-button switch.

7. The circuit device as claimed in claim 1, wherein said voltage step-down unit is a diode.
